(19) United States
(12) Patent Application Publication
(10) Pub. No.: US 2016/0272372 A1
(43) Pub. Date: Sep. 22, 2016

(54) ENHANCED FLYING DISK FOR CONTAINING ADVERTISING MATERIAL AND/OR AMUSEMENT ITEMS

(71) Applicant: Victor McLane, Garfield, KY (US)

(72) Inventor: Victor McLane, Garfield, KY (US)

(21) Appl. No.: 14/660,059

(22) Filed: Mar. 17, 2015

(51) Int. Cl. B65D 25/54; B65D 85/02; B65D 85/38; G06Q 90/00

(52) U.S. Cl. CPC B65D 25/54; G06Q 90/00; B65D 85/02; B65D 85/38

(57) ABSTRACT

An enhanced flying disk for containing and distributing advertising material is disclosed that includes a flying disk with a compartment extending downward from the bottom side of the disk, and residing within the volume of space defined by the bottom of the disk. The compartment has an opening and a lid for closing the compartment so as to retain an object bearing information that can be included within the compartment. The object bearing information can be a round book, a CD, a DVD, or a set of discount coupons, for example. Alternatively, the compartment can contain a toy, an amusement item, a product sample, a souvenir item, candy, or a promotional item. The disk can be transparent, and/or the compartment can be transparent, such that the contents of the compartment can be seen without opening the compartment.

### FIELD OF THE INVENTION

This invention generally relates to flying disks, and more particularly multi-purpose flying disks.

### BACKGROUND

Advertisers routinely use costly and ineffective advertising products and services, such as printed advertisements distributed via postal mail, or printed in newspapers, magazines, etc. Such printed advertisements are often ignored or discarded by recipients, wasting the advertisers' time and money.

Advertisers sometimes distribute promotional products, such as hats, pens, mugs, flying disks, shirts, USB thumb-drives, etc., bearing company logo and contact information, for example. While such products can better grab the attention of potential buyers than traditional printed advertisements on paper, or on the web, these products are substantially costlier to produce and distribute than such traditional advertisements. Moreover, the amount of information that can be conveyed via such promotional products is limited to the amount of information that can be printed on the surface area of the product.

### SUMMARY OF THE INVENTION

The enhanced flying disk of the invention allows advertisers to deliver cost-effective and compelling advertising that is less likely to be ignored or discarded by recipients, thereby saving the advertisers' time and money. The enhanced flying disk of the invention is no more costly to produce than many promotional products, such as hats, pens, mugs, flying disks, shirts, USB thumb-drives, etc., bearing company logo and contact information, yet the amount of information that can be conveyed via the enhanced flying disk of the invention is not limited to the amount of information that can be printed on the surface area of the typical promotional product. More advantages of the invention and its various embodiments are set forth in the detailed description below.

A general aspect of the invention is an enhanced flying disk for containing and distributing advertising material. The enhanced flying disk includes: a flying disk having a top side and a bottom side, the bottom side defining a volume of space; a compartment extending downward from the bottom side and residing within the volume of space, the compartment having an opening; and a lid for removably engaging with the opening of the compartment, thereby closing the compartment so as to contain an object bearing information that can be included within the compartment.

In some embodiments, the object bearing information bears more information than can be presented for advertising or marketing purposes on the top side of the flying disk.

In some embodiments, the object bearing information is a round book. In further embodiments, the round book includes advertising material.

In some embodiments, the flying disk is made from a substantially transparent material, such that an object within the compartment is visible as seen through the top surface of the flying disk.

In some embodiments, the lid has gripping features to facilitate removal of the lid from the compartment.

In some embodiments, the lid has an adhesive material bordering the circumference of the lid so as to engage a top portion of the wall of the compartment.

Another general aspect of the invention is an enhanced flying disk for containing and distributing an amusement item, the enhanced flying disk including: a flying disk having a top side and a bottom side, the bottom side defining a volume of space; a compartment extending downward from the bottom side and residing within the volume of space, the compartment having an opening; and a lid for removably engaging with the opening of the compartment, thereby closing the compartment so as to contain an amusement item that can be included within the compartment.

In some embodiments, the amusement item can be played with separately from the flying disk. In further embodiments, the amusement item is one of: a toy, a souvenir, a book, a free item, a game, a puzzle, candy.

In some embodiments, the flying disk is made from a substantially transparent material, such that an object within the compartment is visible as seen through the top surface of the flying disk.

In some embodiments, the flying disk is made from a substantially opaque material, such that an object within the compartment is not visible as seen through the top surface of the flying disk, so the contents can be a surprise until the compartment is opened.

Another general aspect of the invention is an enhanced flying disk for containing an information-bearing object, the enhanced flying disk including: a flying disk defining an open volume of space; a compartment, attached to the flying disk, the compartment being disposed within the open volume of space, the compartment having an opening; a disk-shaped media object provided within the compartment; and a lid engagable with the opening of the compartment, the compartment being closable by the lid so as to retain an information-bearing object within the compartment.

In some embodiments, the information-bearing object is a disk-shaped media object.

In some embodiments, the disk-shaped media object is one of: a compact disc (CD); a Digital Video Disc (DVD); or a BlueRay Disc.

In some embodiments, the flying disk is transparent.

In some embodiments, the information-bearing object is a round book, the information in the book being one of: advertising messages; or children's stories.

In some embodiments, the lid is transparent.

In some embodiments, the lid has gripping features to facilitate removal of the lid from the compartment.

In some embodiments, the information-bearing object is contained within the compartment.

### BRIEF DESCRIPTION OF THE DRAWINGS

For a fuller understanding of the invention, reference is made to the following detailed description, taken in connection with the accompanying drawings illustrating various embodiments of the present invention, in which:

FIG. 1 is a top/side exploded view of an embodiment of an enhanced flying disk that contains a round book;

FIG. 2 is a top view of a clear embodiment of the enhanced flying disk of FIG. 1, showing a round book contained therein;

FIG. 3 is a side exploded view of the enhanced flying disk, showing the round book before insertion into the compartment, and showing the cap before sealing the book inside the compartment of the enhanced flying disk;

FIG. 4 is a side/bottom exploded view of the enhanced flying disk of FIG. 3;

FIG. 5 is a top/side exploded view of the enhanced flying disk according to another embodiment having a lid with finger holes;

FIG. 6 is a bottom view of the enhanced flying disk of FIG. 5;

FIG. 7 is a top/side view of enhanced flying disk according to another embodiment having a clear lid; and

FIG. 8 is a top/side view of the enhanced flying disk of FIG. 7, having an opaque lid, and containing a CD or DVD instead of a round book.

### DETAILED DESCRIPTION

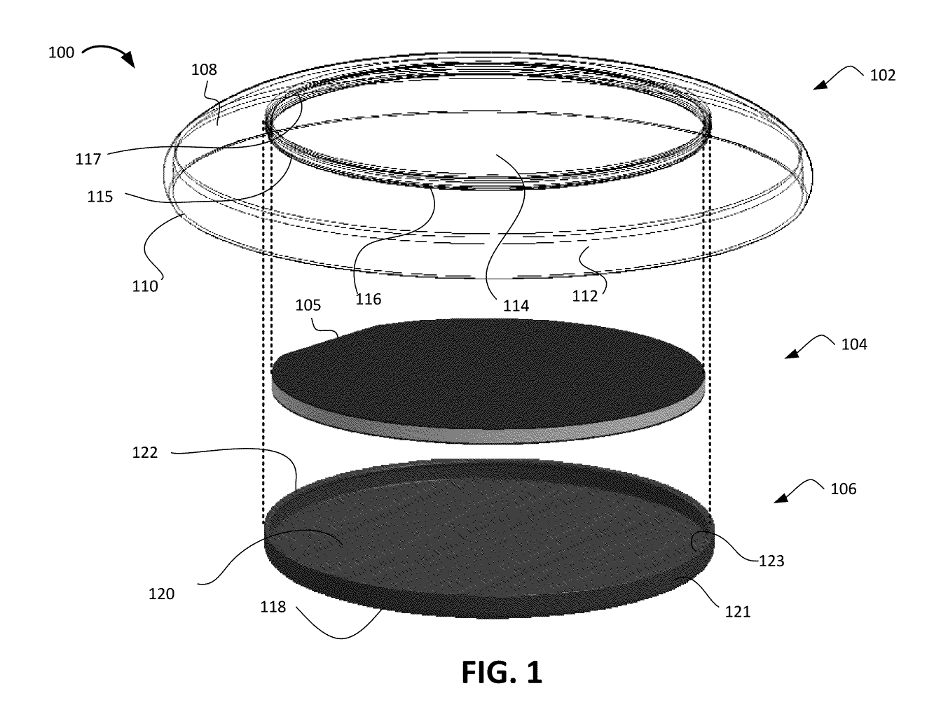

FIG. 1 is a top/side exploded view of an example enhanced flying disk 100. The enhanced flying disk 100 is a disk-shaped assembly and includes a flying disk 102, a round book 104, and a lid 106. As shown in FIG. 1, the round book 104 can be placed inside a compartment 114 of the flying disk 102, and the lid 106 can enclose the book 104 within the compartment 114 of the disk 102. The round book 104 can be a book, booklet, brochure, magazine, or pamphlet containing advertising material, and/or other information, such as printed material having amusement, entertainment, or play value, such as a children's storybook, a picture book, an instruction book, a coloring book, a cut-out book, or a secret code book, for example. The book 104 can include a spine 105 by which pages of the book are bound.

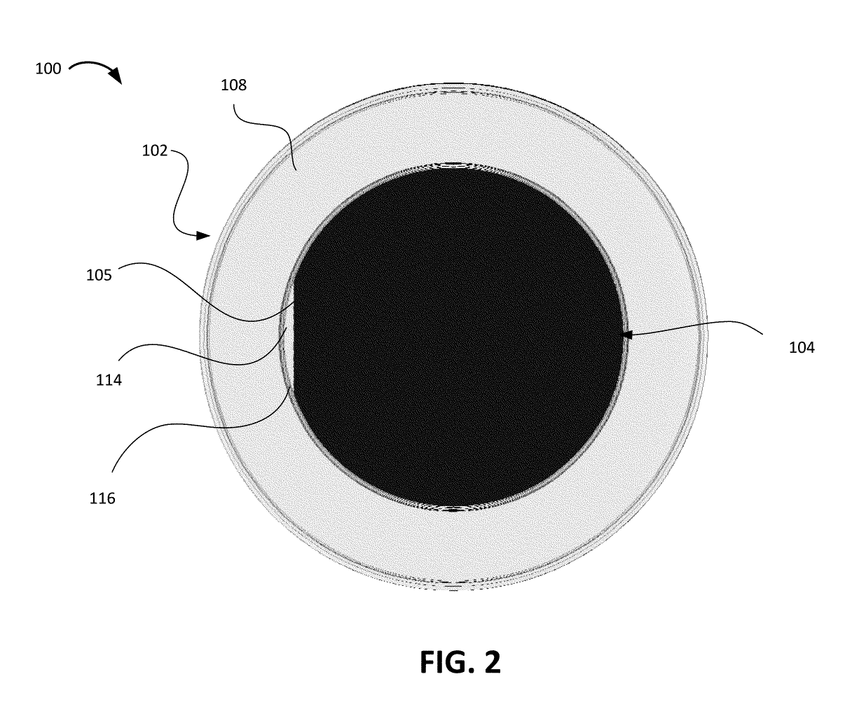

With reference to FIG. 2, the disk 102 can be substantially clear or translucent, so that the book 104 is visible when the book 104 is placed within the disk 100 (e.g., as shown in the top-view of the enhanced flying disk 100 of FIG. 2). The spine 105 also creates a slight opening within the compartment 114 so that the book 104 can be easily removed using a finger or two (as shown in FIG. 2).

As further shown in FIG. 1, the disk 102 has a top surface 108, a sidewall 110, and an open area 112. The top surface 108 and/or the sidewall 110 can be curved to improve the aerodynamics of the flying disk 102 (e.g., when the flying disk is thrown like a Frisbee® disk). Also, the open area 112 creates lift when the disk is thrown. A substantially circular compartment wall 116 is provided within the open area 112 and extending downwardly from an underside of the top surface 108 to form the compartment 114 within the open area 112. The compartment 114 can contain the round book 104. The top surface 108 can be located on a plane substantially parallel to the compartment 114, and can be transparent so that the round book 104 is visible through the top surface 108 of the disk 102.

The lid 106 can be engaged so as to substantially close the compartment 114 and thereby securely enclose the book 104 within the compartment 114 of the disk 102. The lid 106 includes a bottom side 118, a receiving side 120, and a cover flange 122 (FIG. 1). The cover flange 122 is substantially circular and projects perpendicularly from the receiving side 120. The cover flange 122 is placed in engaging relationship with the outside or the inside of the compartment wall 116, the cover flange 122 engaging the compartment wall 116 so as to remain engaged until intentionally removed to access the contents of the compartment 114. The lid 106 encloses and secures the book 104 within the receiving portion 120, and within the compartment 114 of the disk 102.

For example, the compartment wall 116 can be a malleable plastic material and have a diameter slightly larger than that of the cover flange 122.

The cover flange 122 can be made of a relatively stiffer material than that of the compartment wall 116 so that when the cover flange 122 is placed over the compartment wall 116, the cover flange 122 forces the compartment wall 116 inward, thereby causing the compartment wall 116 to bias outward and frictionally engage with the cover flange 116. For example, an outward biasing force of the compartment wall 116 is generated when the cover flange 122 is placed around the compartment wall 116, forcing the compartment wall 116 inward. This biasing force secures the lid 106 to the compartment wall 116 along an internal surface 117 of the compartment wall 116, and along an external surface 121 of the cover flange 122.

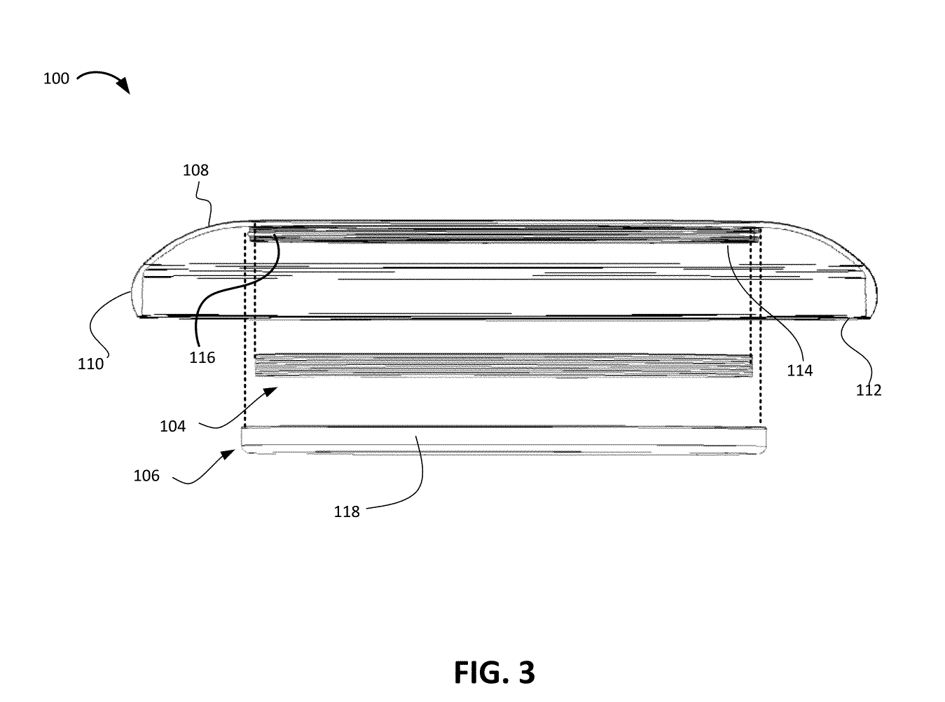

With reference to FIG. 3, alternatively, the diameter of the cover flange 122 can be slightly larger than that of the compartment wall 116, so that when the cover flange 122 is pressed within the compartment wall 116, an external surface 121 of the cover flange 122 contacts an inner surface 118 of the compartment wall 116, and forces the compartment wall 116 outward, generating an inward biasing force. This biasing force secures of the cover flange 122 to the compartment flange 114 along an inner surface 118 of the compartment wall 116 and along an external surface 121 of the cover flange 122.

Alternatively, the compartment wall 116 and cover flange 122 can be cooperatively threaded, and the cover flange 122 can be screwed on to the compartment wall 116. The lid 106 can be made from any number of materials and manufacturing processes.

Referring to FIG. 3, the compartment wall 116 extends substantially perpendicularly from an underside of the top surface 108. The height of the compartment wall 116 is sufficient to accommodate at least one book 104. The book 104 can be placed within the compartment 114, and can be secured within the compartment 114 of the disk 102 by the lid 106.

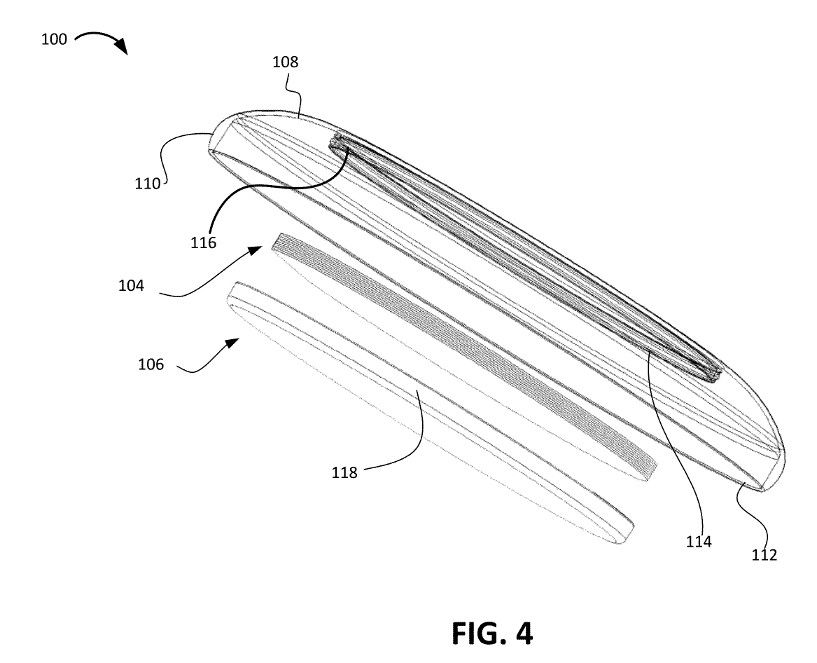

A bottom-side view of the enhanced flying disk 100 is shown in FIG. 4. Since the lid 106 closes the compartment 114 of the disk 102, the lid 106 can secure a book 104 within the compartment 114 so that it remains in place when the disk 102 is thrown.

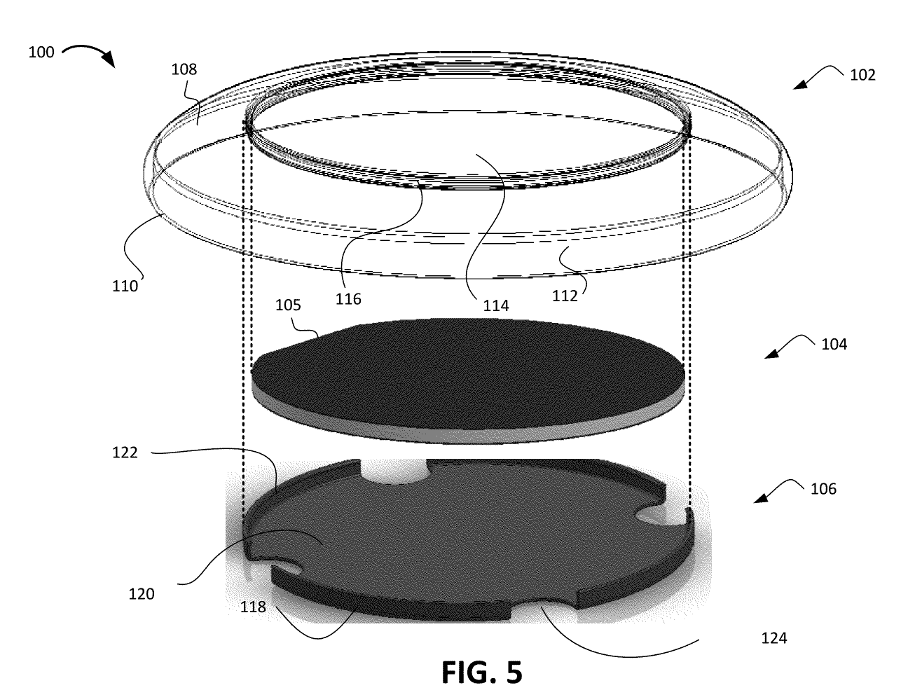

The lid 106 can have different forms than that shown in FIG. 1. For example, referring to FIG. 5, the lid 106 can include a plurality gripping sections 124, e.g., four gripping sections 124. The four gripping sections 124 can help a user to remove the lid 106 from the disk 102. For example, the user can grip the lid 106 via the gripping sections 124, and lift and/or twist the lid 106 to remove the lid 106 from the disk 102.

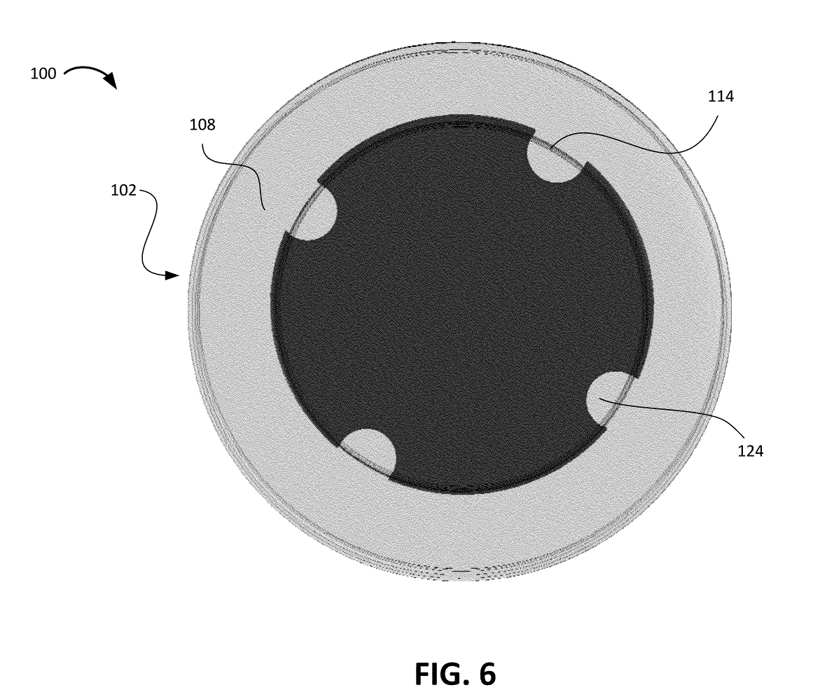

FIG. 6 is a top of view of the enhanced flying disk 100 with the lid 106 shown in FIG. 5. For clarity, the book 104 is not shown, and the top surface 108 is transparent to show the details of the lid 106.

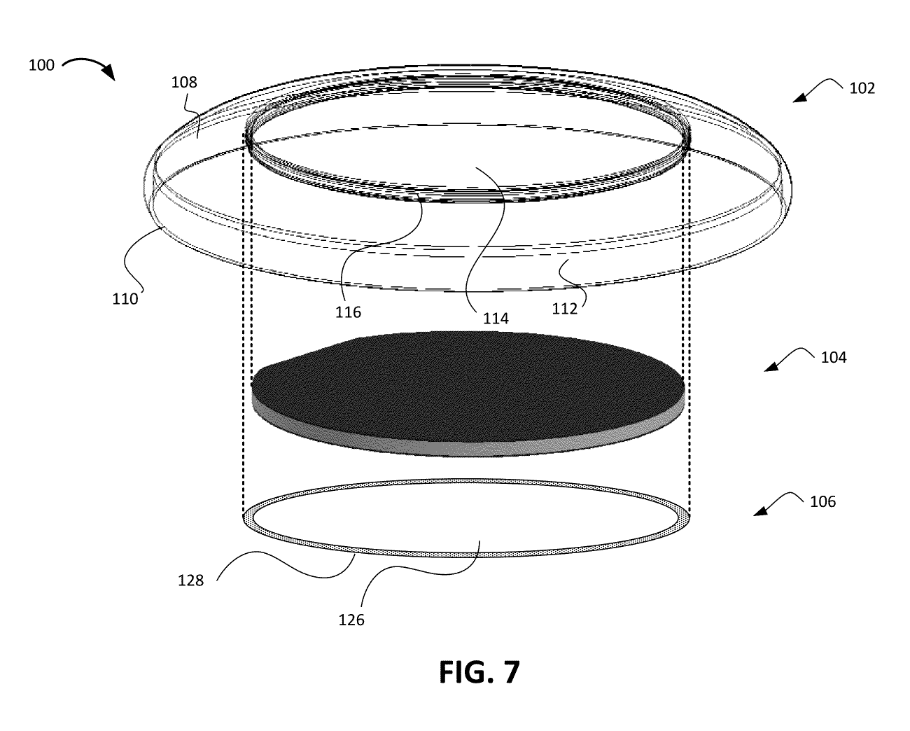

Referring to FIG. 7, the lid 106 in this embodiment does not have a receiving section 120 or a cover flange 122. For example, the lid 106 can be a substantially flat round disk, and can include a plastic surface 126, and an adhesive material 128. The adhesive material 128 can cover a circumferential strip region running around the edge of the round plastic surface 126, and can be wrapped and sealed to the top-most portion of the compartment wall 116, thereby securing the book 104 within the compartment 114 of the disk 102.

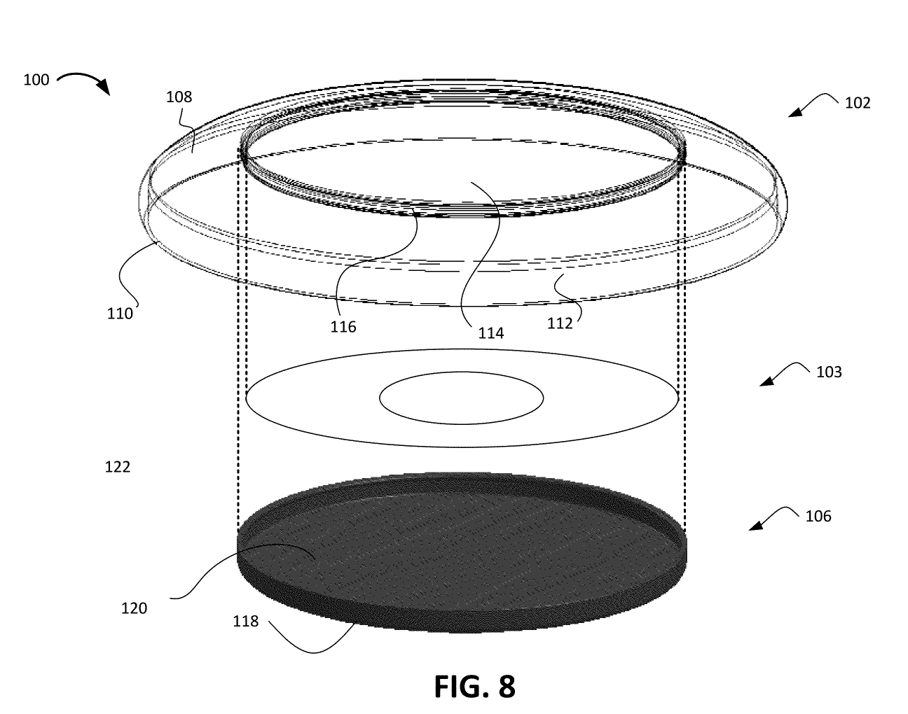

With reference to FIG. 8, in some implementations, the disk 102 can store an object other than a round book 104. For example, the disk 102 can store disk-shaped media, such as a Compact Disc (CD), a Digital Video Disc (DVD), a Blue-Ray Disc, etc. For example, the disk-shaped media 103 can be stored within the compartment 114 of the disk 102.

While particular components are shown in FIGS. 1-8, the enhanced flying disk 100 can include additional, fewer, or differently arranged components than shown.

The disk 102 can be manufactured using Polyethylene Terephthalate plastic (PET, PETE, or PETE), and/or other clear and transparent material. The disk 102 and the cover 106 can be made using Plastic Injection or Vacuum Forming manufacturing processes.

The book 104 can include advertisements, coupons, etc. A particular advertiser can pay a premium fee to have their material printed on the front or back cover of the book 104 so that the particular advertiser's printed material is immediately visible from within the disk 102. The book 104 can be removed from the disk 102, and the remainder of the enhanced flying disk 100 (e.g., the disk 102 with the lid 106 attached to the disk 102, or the disk 102 without the lid 106) can be used for another purpose, such as a toy or a sporting object. For example, the enhanced flying disk 100 can be used as a flying disk for toss games, giving the enhanced flying disk 100 a dual use, providing a substantial advantage over other forms of advertising products and techniques. For example, a consumer can retain the book 104 so that the consumer/potential buyer can review the material in the book 104, while gifting the remainder of the enhanced flying disk 100 to a child or a pet. Thus, the advertising material in the book 104 is retained and reviewed by the consumer, and the remainder of the enhanced flying disk 100 can be enjoyed by another individual. Conversely, when advertising material is printed directly on prior art flying disks, the advertising material on that disk is lost by the consumer and potential buyer when the disk is gifted to another individual. Also, since the enhanced flying disk 100 functions as a toy or a sporting object, advertising material is more likely to be noticed by potential buyers than when advertising material is simply delivered in an ordinary envelope, thereby making the enhanced flying disk 100 a more valuable advertising distribution tool than ordinary mailers.

The enhanced flying disk 100 can function as two products in one. For example, the enhanced flying disk 100 can function as a container and/or delivery mechanism for a round book 104 (e.g., a round book of printed material, such as advertisements). In addition, the enhanced flying disk 100 can be a used as toy (e.g., a flying toss disk) even after the book 104 has been removed from the compartment 114. As a result, information printed within the book 104 is not lost when the remainder of the enhanced flying disk 100 is used as gifted as a toy. Also, the enhanced flying disk 100 can be relatively inexpensive to produce, making the enhanced flying disk 100 an affordable device for small businesses to grow their business through advertising.

Also, the compartment 114 of the enhanced flying disk 100 can contain a collection of round sheets that are stacked and unbound, such as a plurality of separate round coupons from a group of advertisers. Of course, the round coupons can also be bound together at an edge to form a round coupon book.

In other embodiments, the compartment 114 can contain free promotional items and samples of products, such as candy, lotion, soap, shampoo, toothpaste, vitamins, etc.

It is to be understood that the invention is not limited to the specific sizes, shapes, or applications described.

It is to be understood that the disclosure in this specification includes all possible combinations of such particular features, regardless of whether a combination is explicitly described. For example, where a particular feature is disclosed in the context of a particular aspect or embodiment of the invention, that feature can also be used, to the extent possible, in combination with and/or in the context of other particular aspects and embodiments of the invention, and in the invention generally.

Other modifications and implementations will occur to those skilled in the art without departing from the spirit and the scope of the invention as claimed. Accordingly, the above description is not intended to limit the invention, except as indicated in the following claims.

What is claimed is:

1. An enhanced flying disk for containing and distributing advertising material, the enhanced flying disk comprising:
a flying disk having a top side and a bottom side, the bottom side defining a volume of space;
a compartment extending downward from the bottom side and residing within the volume of space, the compartment having an opening; and
a lid for removably engaging with the opening of the compartment, thereby closing the compartment so as to contain an object bearing information that can be included within the compartment.

2. The enhanced flying disk of claim 1, wherein the object bearing information bears more information than can be presented for advertising or marketing purposes on the top side of the flying disk.

3. The enhanced flying disk of claim 1, wherein the object bearing information is a round book.

4. The enhanced flying disk of claim 3, wherein the round book includes advertising material.

5. The enhanced flying disk of claim 1, wherein the flying disk is made from a substantially transparent material, such that an object within the compartment is visible as seen through the top surface of the flying disk.

6. The enhanced flying disk of claim 1, wherein the lid has gripping features to facilitate removal of the lid from the compartment.

7. The enhanced flying disk of claim 1, wherein the lid has an adhesive material bordering the circumference of the lid so as to engage a top portion of the wall of the compartment.

8. An enhanced flying disk for containing and distributing an amusement item, the enhanced flying disk comprising:
a flying disk having a top side and a bottom side, the bottom side defining a volume of space;
a compartment extending downward from the bottom side and residing within the volume of space, the compartment having an opening; and
a lid for removably engaging with the opening of the compartment, thereby closing the compartment so as to contain an amusement item that can be included within the compartment.

9. The enhanced flying disk of claim 8, wherein the amusement item can be played with separately from the flying disk.

10. The enhanced flying disk of claim 8, wherein the amusement item is one of:
a toy, a souvenir, a book, a free item, a game, a puzzle, candy.

11. The enhanced flying disk of claim 8, wherein the flying disk is made from a substantially transparent material, such that an object within the compartment is visible as seen through the top surface of the flying disk.

12. The enhanced flying disk of claim 8, wherein the flying disk is made from a substantially opaque material, such that an object within the compartment is not visible as seen through the top surface of the flying disk, so the contents can be a surprise until the compartment is opened.

13. An enhanced flying disk for containing an information-bearing object, the enhanced flying disk comprising:
a flying disk defining an open volume of space;
a compartment, attached to the flying disk, the compartment being disposed within the open volume of space, the compartment having an opening;
a disk-shaped media object provided within the compartment; and
a lid engagable with the opening of the compartment, the compartment being closable by the lid so as to retain an information-bearing object within the compartment.

14. The enhanced flying disk of claim 13, wherein information-bearing object is a disk-shaped media object.

15. The enhanced flying disk of claim 14, wherein the disk-shaped media object is one of:
a compact disc (CD)
a Digital Video Disc (DVD);
a BlueRay Disc.

16. The enhanced flying disk of claim 13, wherein the flying disk is transparent.

17. The enhanced flying disk of claim 13, wherein the information-bearing object is a round book, the information in the book being one of:
advertising messages; children's stories.

18. The enhanced flying disk of claim 13, wherein the lid is transparent.

19. The enhanced flying disk of claim 13, wherein the lid has gripping features to facilitate removal of the lid from the compartment.

20. The enhanced flying disk of claim 13, wherein the information-bearing object is contained within the compartment.
